(19) United States
(12) Patent Application Publication
(10) Pub. No.: US 2006/0015477 A1
(43) Pub. Date: Jan. 19, 2006

(54) Method for managing profiles and management system of profiles

(75) Inventor: Masateru Mitani, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/180,126

(22) Filed: Jul. 12, 2005

(30) Foreign Application Priority Data
Jul. 16, 2004 (JP) 2004-210767

(51) Int. Cl. G06F 7/00

(52) U.S. Cl. 707/1

(57) ABSTRACT

According to the present invention, even if the maximum number of profiles capable of being stored are already stored, profile data being newly made is not be disappeared, and a suitable profile stored can be deleted. A storage portion of temporary storage profiles 3 capable of storing temporarily profile data being newly made is constructed in a driver. In case that the maximum number of profiles capable of being stored are already stored, profile data being newly made is stored in a temporary storage profile. Subsequently, a suitable profile already stored in a storage portion of normal storage profiles 2 is picked, the content thereof is displayed, and the profile is deleted. Then, the said profile data being newly made is picked from the temporary storage profile to store as a new profile.

### BACKGROUND OF THE INVENTION

1. Field of the Invention

The present invention relates to a method for managing profiles to make, alter, delete profiles stored in a driver for sending control data to a peripheral device such as a printer, a scanner or the like connected to a computer, and so on, and a management system of profiles.

2. Related Art Statement

As to a system in which a peripheral device such as a printer, a scanner or the like is connected to a computer, software of driver for sending control data to the peripheral device such as a printer, a scanner or the like is installed in the computer in advance, and after various setting of device is performed in the driver, control data is sent to the peripheral device such as a printer, a scanner or the like from the driver so as to make the peripheral device such as a printer, a scanner or the like carry out the prescribed operation.

The setting of device performed in the driver can be stored as a profile in an area of memory in the driver. Making a profile can be performed, as shown in FIG. 1, by starting the driver and displaying the general frame of driver 10 on a monitor.

In the general frame of driver 10, for example, after setting-up, job type, layout, effectiveness, quality of picture and the like is set suitably, when the storage button 11 is clicked, as shown in FIG. 2, the profile name entry frame 20 is displayed. In the profile name entry frame 20, when a suitable name is entered in the profile name entry section 21 and the OK button 22 is clicked, a new profile having the name is made and stored in an area of memory in the driver.

In case that the content of the profile already made and stored is confirmed, in the general frame of driver 10, the profile selection button 12 is clicked to display the profile number in the profile indication section 13. Subsequently, when the profile number is suitably selected and clicked, the content of the profile corresponding to the profile number is displayed on the general frame of driver 10.

Further, in the profile name entry frame 20, in case that the name already used is entered in the profile name entry section 21, as shown in FIG. 3, the overwriting confirmation frame 30 is displayed, and when the OK button 31 is clicked, the content of the profile previously made is altered.

As described above, in the general frame of driver 10, a plurality of profiles can be made and stored, and the content thereof can be altered. However, even if so many profiles can be indicated in the profile indication section 13, the desired profile is hard to search, and also, the capacity of resources (memory, registry and the like) usable for storing profiles is limited.

Accordingly, the number of profiles which can be made, stored and indicated in the profile indication section 13 is generally set an upper limit to.

Therefore, when a suitable setting is performed in the general frame of driver 10 and the storage button 11 is clicked, in case that the maximum number of profiles capable of storing are already stored, as shown in FIG. 4, a error message frame 40 is displayed.

Then, the operator has to make the general frame of driver 10 returned once to indicate profile numbers in the profile indication section 13, and select a suitable profile number, delete the profile corresponding to the number, and subsequently make and store a new profile.

Meanwhile, as to making, alteration and deletion of profiles, in condition that many clients are connected through a network, there is proposed the method wherein, in case that a part or all of the content of a profile sent from a client is correspond to the content of a profile stored in the server, the stored profile is automatically deleted and the profile sent from the client is stored in the server (Japanese Patent Laid-Open No. 199229/2002 Publication). Further, there is proposed the method wherein, the number of clients who accessed a profile stored in the server, the access time, and the like are considered, and in case that they are over the prescribed deletion limit, the corresponding saved profile is automatically deleted (Japanese Patent Laid-Open No. 58588/2004 Publication).

So far, in case that the maximum number of profiles capable of storing is already stored and the error message frame 40 is displayed, the general frame of driver 10 is returned once to indicate the profile number in the profile indication section 13, and when suitable profile number is selected and the profile corresponding to the number is deleted, the content of the profile corresponding to the selected number is displayed on the general frame of driver 10, and the profile data being made which is intended to be stored newly is disappeared, therefore, it is necessary to make the profile data again from the beginning.

Meanwhile, in the methods of the above described patent documents, since profiles are stored, altered, deleted and so on automatically, the contents thereof can not be confirmed, therefore, there is a possibility that profiles are stored, altered, deleted and so on by mistake, even if the profiles are not suitable for storing, altering, deleting and the like according to the contents thereof.

### SUMMARY OF THE INVENTION

The present invention has been accomplished to overcome the conventional problem described above, and has it's object to provide a method for managing profiles wherein even if the maximum number of the profiles capable of being stored are already stored, profile data being made which is intended to store newly is not disappeared, and moreover, a suitable profile can be deleted after confirming the content of the profile already stored, and subsequently, a profile newly made can be stored immediately, and management system of profiles.

For achieving the above-described objects, the invention relates to a method for managing profiles, wherein in case that the maximum number of profiles capable of being stored are already stored, profile data under making newly is stored in the temporary storage profile, next, a suitable profile already stored is picked, the content of the profile is displayed, the profile is deleted, and then, the said profile data being made newly is picked from the temporary storage profile and stored as a new profile.

Further, the present invention relates to the management system of profiles which is constituted in the driver, and comprises a storage portion of normal storage profiles capable of storing a prescribed number of profiles; a storage portion of temporary storage profiles capable of temporarily storing profile data under making newly; a processing portion of profiles capable of selectively picking, storing, altering and deleting a profile from the storage portion of normal storage profiles and the storage portion of temporary storage profiles.

Here, the said storage portion of temporary storage profiles may be constructed in the same area of memory as the said storage portion of normal storage profiles, and may be capable of accessing only in case that the maximum number of profiles which can be stored are already stored.

### BRIEF DESCRIPTION OF THE DRAWINGS

FIG. 1 is an illustration showing one embodiment of a general frame of driver;

FIG. 2 is an illustration showing one embodiment of a profile name entry frame;

FIG. 3 is an illustration showing one embodiment of a overwriting confirmation frame;

FIG. 4 is an illustration showing one embodiment of an error message frame;

FIG. 5 is a schematic structural illustration of a management system of profiles according to the present invention;

FIG. 6 is a flowchart of a method for managing profiles according to the present invention;

FIG. 7 is a flowchart showing a storage process of profiles;

FIG. 8 is a flowchart showing a deletion process of profiles;

FIG. 9 is an illustration showing one embodiment of a profile impossible frame;

FIG. 10 is an illustration showing another embodiment of a general frame of driver; and

FIG. 11 is a flowchart showing a process after judgment whether the maximum number of profiles are stored is performed.

### DETAILED DESCRIPTION OF THE INVENTION

The preferred embodiments of the method for managing profiles and the management system of profiles according to the present invention will be described in detail with reference to the drawings below.

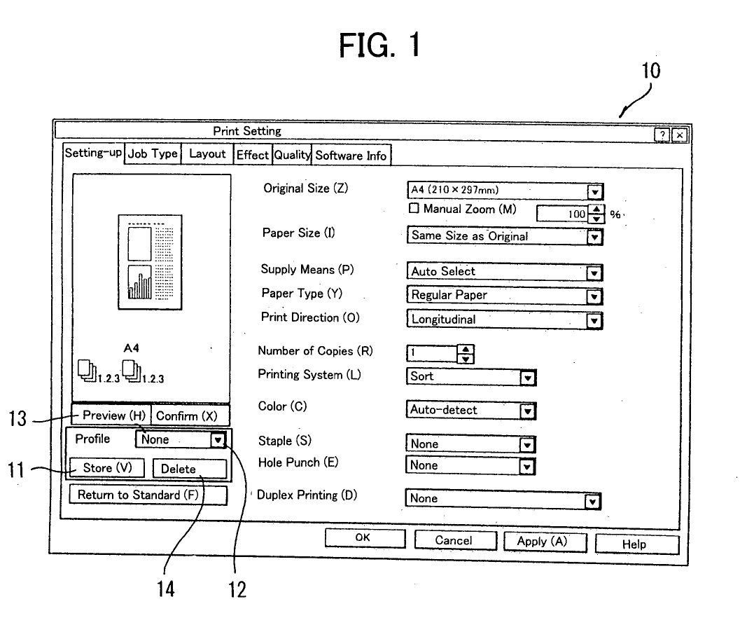

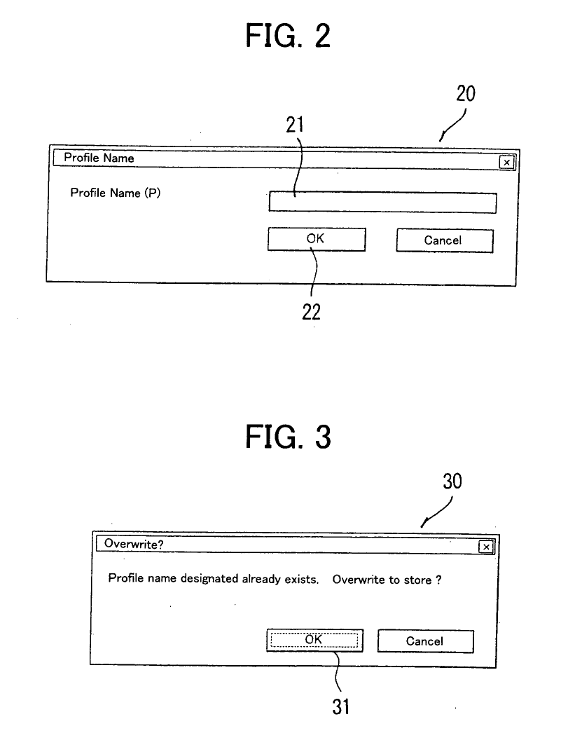

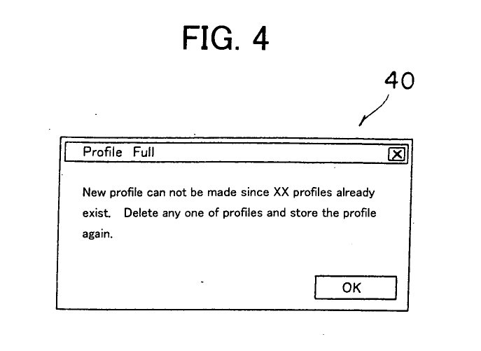

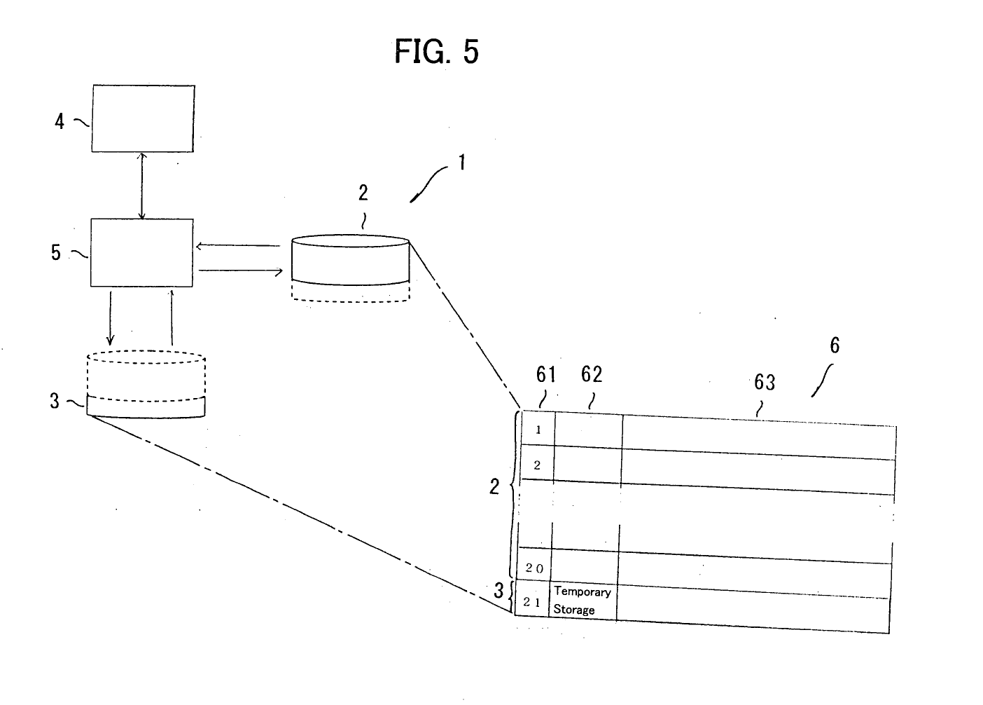

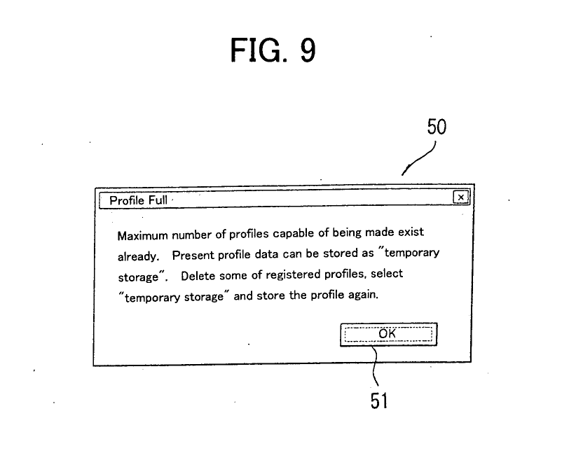

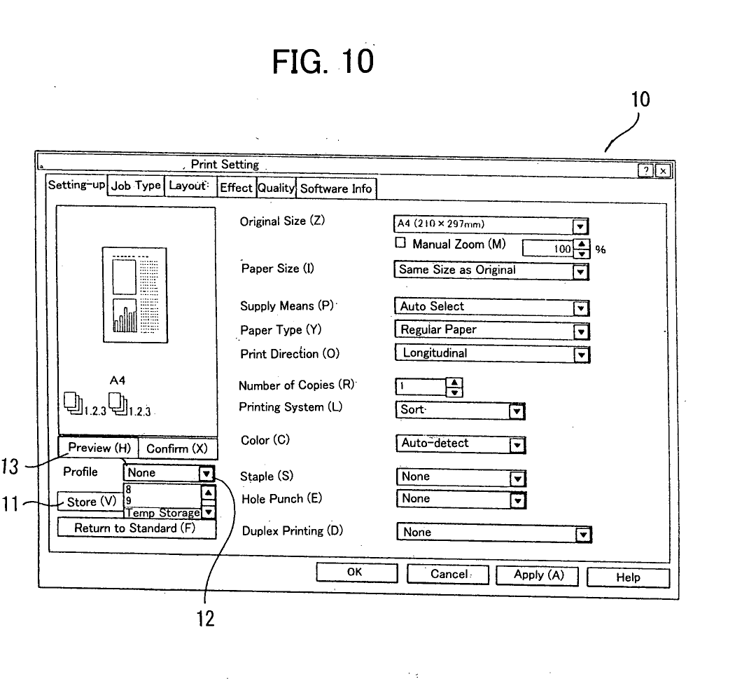

FIG. 1 is an illustration showing one embodiment of a general frame of driver, FIG. 2 is an illustration showing one embodiment of a profile name entry frame, FIG. 3 is an illustration showing one embodiment of a overwriting confirmation frame, FIG. 4 is an illustration showing one embodiment of an error massage frame, FIG. 5 is a schematic structural illustration of a management system of profiles according to the present invention, FIG. 9 is an illustration showing one embodiment of a profile impossible frame, and FIG. 10 is an illustration showing another embodiment of a general frame of driver.

The management system of profiles according to the present invention 1 is constituted in a driver, and as shown in FIG. 5, comprises a storage portion of normal storage profiles 2 capable of storing a prescribed number of profiles; a storage portion of temporary storage profiles 3 capable of temporarily storing profile data being made newly; and a processing portion of profiles 4 capable of making profiles and picking, storing, altering and deleting profiles selectively from the storage portion of normal storage profiles 2 and the storage portion of temporary storage profiles 3.

Here, the reference numeral 5 shows the temporary memory portion of data in which profile data is memorized temporarily to make, indicate the profile data and so on.

In the management system of profiles according to the present invention 1, the storage portion of normal storage profiles 2 and the storage portion of temporary storage profiles 3 are constituted in the same memory area, and the number 1 to 20 of the profile storage table 6 constitute the storage portion of normal storage profiles 2 and the number 21 of the profile storage table 6 constitutes the storage portion of temporary storage profiles 3, as shown in FIG. 5. Accordingly, in the present embodiment, the maximum number of profiles capable of being stored is 20.

And also, the storage portion of temporary storage profiles 3 of number 21 can be accessed only in case that 20 profiles, the maximum number of profiles capable of being stored, is already stored.

In the profile storage table 6, a profile number is stored as data in the first section 61, a profile name is stored as data in the second section 62, and content of a profile is stored as data in the third section 63.

As to the storage portion of temporary storage profiles 3 of number 21, the name “temporary storage” is stored as data in the second section 62, and content of a temporary storage profile is stored as data in the third section 63.

Next, the case where the method for managing profiles is carried out by the management system of profiles according to the present invention 1 will be described. The case where the method is applied for a printer as a peripheral device, that is, the case where the method is applied for a printer driver, will be described below.

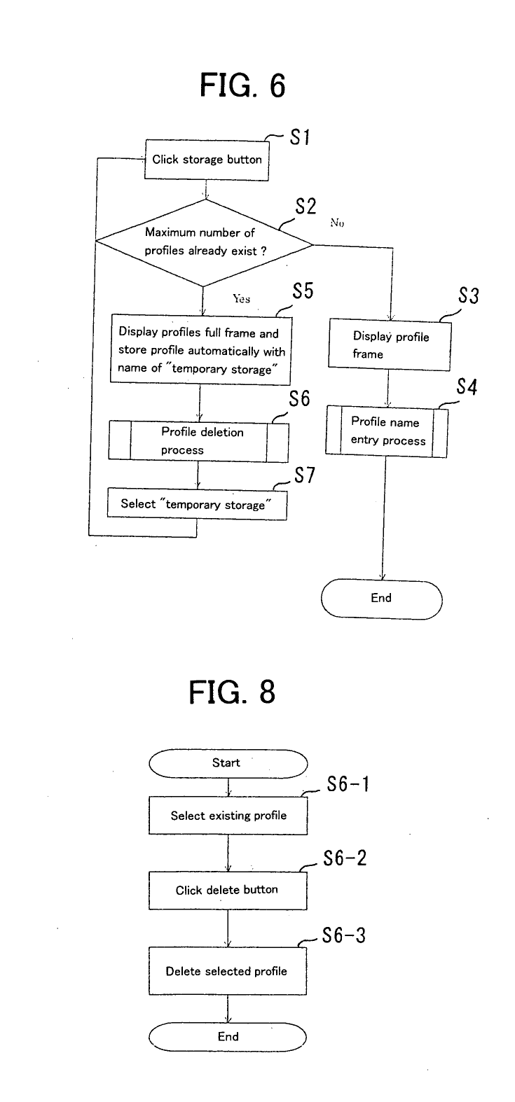

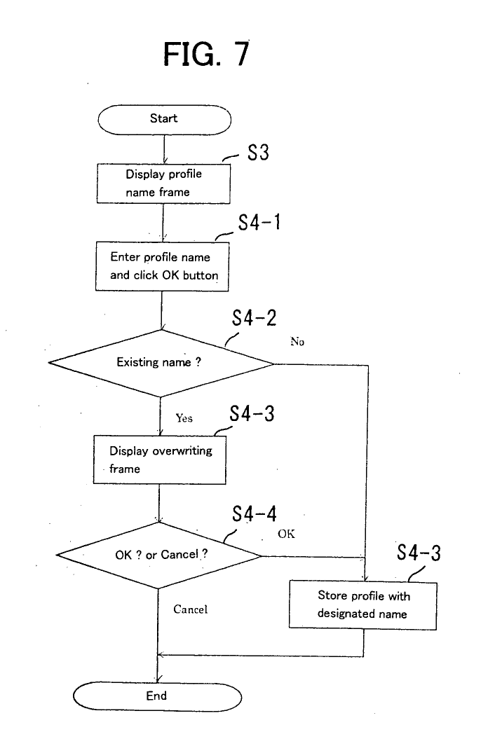

In order to make a new profile, in the same way as before, as shown in FIG. 1, the printer driver is started to display the general frame of driver 10 on the monitor. Explanation referring to the flowcharts shown in FIG. 6 to 8 will be made below.

In the general frame of driver 10, after a suitable print setting of setting-up, job type, layout, effectiveness, quality of picture and the like is performed, a storage button 11 is clicked (S1). Here, during making print setting data, the print setting data is stored temporarily in the temporary memory portion of data 5 as profile data.

When the storage button 11 is clicked, judgment whether the maximum number of profiles (20 as to the present embodiment) are already stored in the storage portion of normal storage profiles 2 is performed by the profile processing portion 4 (S2), and in case that the maximum number of profiles are not yet stored, as shown in FIG. 2, the profile name entry frame 20 is displayed (S3).

In the profile name entry frame 20, when a suitable name is entered in a profile name entry section 21 and a OK button 22 is clicked (S4-1), judgment whether the name is already used is performed by the profile processing portion 4 (S4-2), and in case that the name is not yet used, a new profile having the name is made and stored in the position of the prescribed profile number of the storage portion of normal storage profiles 2 by the profile processing portion 4 (S4-3).

Judgment whether the name is already used is performed (S4-2), and in case that the name is already used, as shown in FIG. 3, a overwriting confirmation frame 30 is displayed (S4-4), and when a OK button 31 is clicked, the profile already made is deleted and a new profile having the name is made and stored in the position of the corresponding profile number of the storage portion of normal storage profiles 2 by the profile processing portion 4 (S4-3).

Judgment whether the maximum number of profiles are already stored in the storage portion of normal storage profiles 2 is performed (S2), and in case that the maximum number of profiles are already stored, as shown in FIG. 9, a profile impossible frame 50 is displayed (S5).

In the profile impossible frame 50, when a OK button 51 is clicked, the profile data temporarily stored in the temporary memory portion of data 5 is temporarily stored in the storage portion of temporary storage profiles 3 by the profile processing portion 4 (S5).

Then, the operator makes the general frame of driver 10 returned once to indicate profile numbers in the profile indication section 13, and selects a suitable profile number to display the content of the profile according to the number (S6-1).

After confirming the content of the selected profile, when the delete button 14 is clicked as shown in FIG. 1 (S6-2), the profile already made in the position of the according profile number of the profile storage portion of normal storage profile 2 is deleted by the profile processing portion 4 (S6-3).

After deleting the unnecessary profile, the operator makes the general frame of driver 10 returned again to indicate the name “temporary storage” of the temporary storage profile in the profile indication section 13 as shown in FIG. 10, and selects “temporary storage” (S7).

Then, the profile data stored temporarily in the storage portion of temporary storage profile 2 is picked, is displayed on the general frame of driver 10, and is stored temporarily in the temporary memory portion of data 5 again by the profile processing portion 4.

When the storage button 11 is clicked (S61), judgment whether the maximum number of profiles (20 as to the present embodiment) are already stored in the storage portion of the normal storage profile 2 is performed by the profile processing portion 4 (S2). However, there became the situation where the maximum number of profiles are not yet stored so that the profile name entry frame 20 is displayed as shown in FIG. 2 (S3).

Accordingly, in the profile name entry frame 20, when a suitable name is entered in the profile name entry section 21 and the OK button 22 is clicked (S4-1), a new profile having the name is made and stored in the position of the deleted profile number of the storage portion of normal storage profile 2 by the profile processing portion 4 (S4-3).

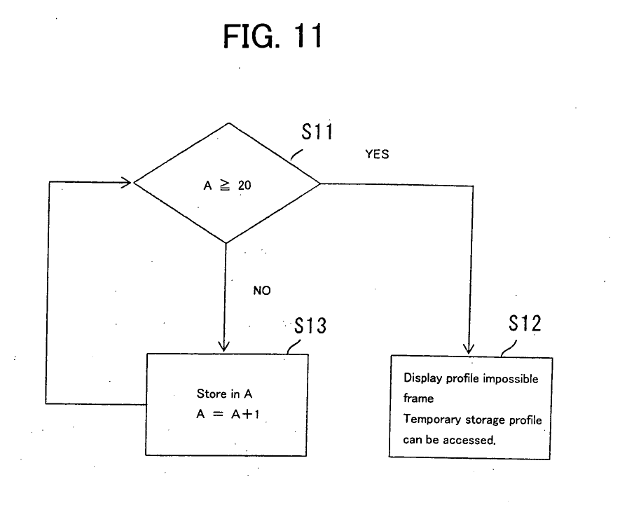

In the above-mentioned case, Judgment whether the maximum number of profiles (20 as to the present embodiment) are already stored in the storage portion of normal storage profiles 2 (S2) is performed concretely by the processing method as shown in FIG. 11.

Namely, the routine in which the variable A is set to 0 as the initial value in advance, and 1 is added to the variable A whenever a profile is made newly and stored in the storage portion of normal storage profiles 2, is formed.

In that case, if the maximum number of profiles (20 as to the present embodiment) are already stored in the storage portion of normal storage profiles 2, the variable A should be 20. Therefore, Judgment whether the maximum number of profiles are already stored can be performed by observing whether there is in the situation of A≧20.

After a suitable print setting is performed in the general frame of driver 10, when the storage button 11 is clicked, judgment whether the variable A is in the situation of A≧20 is performed (S11). In case that there is in the situation of A≧20, as shown in FIG. 9, the profile impossible frame 50 is displayed and the situation where the storage portion of temporary storage profiles 3 can be accessed is formed (S12).

On the other hand, judgment whether the variable A is in the situation of A≧20 is performed (S11), and in case that there is in the situation of A<20, as shown in FIG. 2, the profile name entry frame 20 is displayed and the situation where the storage portion of temporary storage profiles 3 can not be accessed is formed. And also, 1 is added to the variable A so that there is in the situation of A=A+1 (S13).

As mentioned above, according to the method for managing profiles of the present invention, even if the maximum number of profiles capable of being stored are already stored, profile data being made which is intended to be stored newly can be stored in the temporary storage profile. Therefore, the profile data being made is not disappeared and it is not necessary to make the profile data from the beginning so that profiles can be made and stored very efficiently.

Further, according to the method for managing profiles of the present invention, profile data being made which is intended to be stored newly can be stored in the temporary storage profile. Therefore, after confirming the content of the profile already stored, a suitable profile can be deleted and there is no fear of deleting the necessary profile and so on by mistake, so that profiles can be deleted very safely and surely.

According to the management system of profiles of the present invention, the method for managing profiles of the present invention can be carried out suitably. Further, it is more preferable that the storage portion of temporary storage profiles is constituted in the same memory area as the storage portion of normal storage profiles, and can be accessed only in case that the maximum number of profiles capable of being stored are already stored. In that case, the necessary capacity of memory can be reduced.

What is claimed is:

1. A method for managing profiles comprising:
storing profile data being newly made in a temporary storage profile in case that the maximum number of profiles capable of being stored are stored already;
picking a suitable profile already stored to display the content of the profile and delete the profile; and
picking the profile data being newly made from the temporary storage profile to store as a new profile.

2. A management system of profiles which is constructed in a driver, comprising:
a storage portion of normal storage profiles capable of storing a prescribed number of profiles;
a storage portion of temporary storage profiles capable of storing profile data being newly made temporarily; and
a processing portion of profiles capable of selectively picking, storing, altering and deleting a profile from the storage portion of normal storage profile and the storage portion of temporary storage profiles.

3. The management system of profiles according to claim 2:
wherein the said storage portion of temporary storage profiles is constructed in the same area of memory as the said storage portion of temporary storage profiles, and can be accessed only in case that the maximum number of profiles capable of being stored are already stored.
